(19) United States
(12) Patent Application Publication
(10) Pub. No.: US 2025/0234384 A1
(43) Pub. Date: Jul. 17, 2025

(54) BANDWIDTH PART (BWP) SWITCHING FOR CONFIGURED GRANT SMALL DATA TRANSMISSION

(71) Applicant: Nokia Technologies Oy, Espoo (FI)

(72) Inventors: Chunli WU, Beijing (CN); Samuli Heikki TURTINEN, Oulu (FI); Jussi-Pekka KOSKINEN, Oulu (FI)

(21) Appl. No.: 18/702,697

(22) PCT Filed: Oct. 22, 2021
(86) PCT No.: PCT/CN2021/125551

§ 371 Date: Apr. 18, 2024

(51) Int. Cl. H04W 74/0833; H04L 5/00; H04W 74/08; H04W 76/20

(52) U.S. Cl. CPC H04W 74/0833; H04L 5/0053; H04W 74/0891; H04W 76/20

(57) ABSTRACT

Systems, methods, apparatuses, and computer program products for bandwidth part (BWP) switching for configured grant (CG) small data transmission (SDT) are provided. One method may include, when a switch to an initial BWP for a random access (RA) procedure is triggered due to a configured grant (CG)-small data transmission (SDT) condition becoming invalid, autonomously switching, by a user equipment (UE), to a dedicated BWP configured with the CG SDT when the CG SDT condition becomes valid.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for bandwidth part (BWP) switching for configured grant (CG) small data transmission (SDT).

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus including at least one processor and at least one memory comprising computer program code. The at least one memory and computer program code configured, with the at least one processor, to cause the apparatus at least to: when a switch to an initial bandwidth part (BWP) for a random access (RA) procedure is triggered due to a configured grant (CG)-small data transmission (SDT) condition becoming invalid, autonomously switching to a dedicated bandwidth part (BWP) configured with the configured grant (CG)-small data transmission (SDT) when the configured grant (CG)-small data transmission (SDT) condition becomes valid.

An embodiment may be directed to a method including, when a switch to an initial bandwidth part (BWP) for a random access (RA) procedure is triggered due to a configured grant (CG)-small data transmission (SDT) condition becoming invalid, autonomously switching, by a user equipment (UE), to a dedicated bandwidth part (BWP) configured with the configured grant (CG)-small data transmission (SDT) when the configured grant (CG)-small data transmission (SDT) condition becomes valid.

An embodiment may be directed to an apparatus including, when a switch to an initial bandwidth part (BWP) for a random access (RA) procedure is triggered due to a configured grant (CG)-small data transmission (SDT) condition becoming invalid, means for autonomously switching to a dedicated bandwidth part (BWP) configured with the configured grant (CG)-small data transmission (SDT) when the configured grant (CG)-small data transmission (SDT) condition becomes valid.

An embodiment may be directed to an apparatus including at least one processor and at least one memory comprising computer program code. The at least one memory and computer program code configured, with the at least one processor, to cause the apparatus at least to transmit a command to a user equipment (UE) to switch to a dedicated bandwidth part (BWP) configured with configured grant (CG)-small data transmission (SDT).

An embodiment may be directed to a method that includes transmitting a command to a user equipment (UE) to switch to a dedicated bandwidth part (BWP) configured with configured grant (CG)-small data transmission (SDT).

An embodiment may be directed to an apparatus that includes means for transmitting a command to a user equipment (UE) to switch to a dedicated bandwidth part (BWP) configured with configured grant (CG)-small data transmission (SDT).

An embodiment may be directed to an apparatus including at least one processor and at least one memory comprising computer program code. The at least one memory and computer program code configured, with the at least one processor, to cause the apparatus at least to receive, from a network node, a command to switch to a dedicated bandwidth part (BWP) configured with configured grant (CG)-small data transmission (SDT), and to switch to the dedicated bandwidth part (BWP) configured with configured grant (CG)-small data transmission (SDT).

An embodiment may be directed to a method that may include receiving, at a user equipment (UE), a command from a network node to switch to a dedicated bandwidth part (BWP) configured with configured grant (CG)-small data transmission (SDT). The method may also include switching, by the user equipment (UE), to the dedicated bandwidth part (BWP) configured with configured grant (CG)-small data transmission (SDT).

An embodiment may be directed to an apparatus including means for receiving, from a network node, a command to switch to a dedicated bandwidth part (BWP) configured with configured grant (CG)-small data transmission (SDT). The apparatus may also include means for switching to the dedicated bandwidth part (BWP) configured with configured grant (CG)-small data transmission (SDT).

### BRIEF DESCRIPTION OF THE DRAWINGS

For proper understanding of example embodiments, reference should be made to the accompanying drawings, wherein:

FIG. 1 illustrates an example signaling diagram, according to an example embodiment;

FIG. 2 illustrates an example signaling diagram, according to an example embodiment;

FIG. 3 illustrates an example flow diagram of a method, according to an example embodiment;

FIG. 4A illustrates an example flow diagram of a method, according to an example embodiment;

FIG. 4B illustrates an example flow diagram of a method, according to an example embodiment;

FIG. 5A illustrates an example block diagram of an apparatus, according to an embodiment; and

FIG. 5B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for BWP switching for CG SDT, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

One problem relating to NR small data transmissions may include how to avoid the signalling overhead and delay associated with transition from a radio resource control (RRC) inactive state (RRC_INACTIVE) to a RRC connected state (RRC_CONNECTED) to perform a small data transmission. Therefore, small data transmission in RRC_INACTIVE for both random access (RA)-based SDT and CG-SDT are being considered.

For the RRC_INACTIVE state, it is expected that UL small data transmissions for RACH-based schemes (i.e., 2-step and 4-step RACH) will be enabled. A general procedure to enable user plane (UP) data transmission for small data packets from INACTIVE state (e.g., using MsgA or Msg3) is expected to be provided. Flexible payload sizes larger than the Release-16 common control channel (CCCH) message size currently possible for INACTIVE state for MsgA and Msg3 to support UP data transmission in UL (actual payload size can be up to network configuration) should be enabled. In addition, context fetch and data forwarding (with and without anchor relocation) in INACTIVE state for RACH-based solutions will be enabled.

Furthermore, transmission of UL data on pre-configured physical uplink shared channel (PUSCH) resources (i.e., reusing the configured grant type 1) when timing advance (TA) is valid will be enabled. This may include a general procedure for small data transmission over configured grant type 1 resources from INACTIVE state, and/or configuration of the configured grant type1 resources for small data transmission in UL for INACTIVE state.

It has been agreed that contention-free random access (CFRA) is not supported for RA-SDT, and that the separate search space is common to the UEs performing RA-SDT. It may be assumed that a UE-specific search space is configured for UEs performing CG-SDT. The UE may need to monitor paging after the UE initiates SDT for system information change. A CG-SDT resource can be configured on either initial BWP or separate SDT BWP.

Additionally, scheduling request (SR) resource is not configured for SDT. Therefore, when the buffer status report (BSR) is triggered by SDT data, the UE will trigger random access (RA) because SR resource is not available.

If none of the reference signal received power (RSRP) of the synchronization signal blocks (SSB) is above a RSRP threshold of CG-SDT criteria in the type selection phase, a UE should select RA-SDT if the RA-SDT criteria is met. In this case, medium access control (MAC) protocol data unit (PDU) rebuilding is not required. During a subsequent configured grant (CG) transmission phase (i.e., after the UE has received a response from the network), the UE can initiate at least legacy RACH procedure (e.g., trigger due to no UL resources). No MAC PDU rebuilding is required. It is yet to be determined if the RA-SDT RA resources can be used for subsequent data. At least the following conditions have been agreed: (1) no qualified SSB when the evaluation is performed; (2) when TA is invalid; (3) when SR is triggered due to lack of UL resource.

A UE should release CG-SDT resource (if stored) when UE initiates RRC resume procedure from another cell, which is different from the cell in which the RRC release is received. The cell radio network temporary identifier (C-RNTI) previously configured in RRC_CONNECTED state is used for the UE to monitor physical downlink control channel (PDCCH) in CG-SDT. Configured scheduling (CS)-RNTI based dynamic retransmission mechanism can be reused for CG-SDT. The CS-RNTI may or may not be the same one as the one previously configured in RRC_CONNECTED or a new CS-RNTI may be provided to the UE. During the subsequent new CG transmission phase, for the purpose of CG resource selection, the UE re-evaluates the SSB for subsequent CG transmission.

It is expected that at least the following parameters may be included in the CG-SDT configuration: the new TA timer in RRC_INACTIVE, the RSRP change threshold for TA validation mechanism in SDT, and/or the SSB RSRP threshold for beam selection (i.e., UE selects the beam and associated CG resource for data transmission). These parameters may or may not be common for multiple CG-SDT configurations or may be per CG-SDT configuration.

During subsequent CG transmission, it was agreed that legacy RA procedure can be triggered at least: (1) when there is no qualified SSB when the evaluation is performed; (2) when TA is invalid; and/or (3) when SR is triggered due to lack of UL resource. If the CG-SDT resource is configured on a dedicated BWP and there is no RA resource configured on the dedicated BWP, the UE would switch to initial BWP to perform RACH as specified in legacy procedures.

However, it is currently not clear if and how a UE would be able to be switched back to the dedicated BWP when the beam for CG becomes available again or when the TA is valid again or UL resources are available after the RA procedure. Certain example embodiments may solve at least this issue, as well as other problems that may not be explicitly discussed herein. For instance, some embodiments may provide systems and methods for BWP switching for CG SDT, as discussed in detail below.

An example embodiment may provide a method for UE autonomous switching back to the dedicated BWP configured with CG-SDT. In one example, if the switching to initial BWP for RA was triggered by having no valid TA, the UE may autonomously switch back to the dedicated BWP configured with CG-SDT when the UE obtains valid TA again upon the RA completion. According to one option, the UE may switch to dedicated BWP upon sending an acknowledgement for the contention resolution message (e.g., Msg4/MsgB). In one option, the UE may indicate, during the RA procedure in initial BWP, that the UE switched BWP from dedicated CG-SDT BWP possibly with an indication of a reason of “no-valid TA”.

In one example, if the switching to initial BWP for RA was triggered by having no valid SSB for CG-SDT, the UE may autonomously switch back to the dedicated BWP configured with CG-SDT when the UE SSB configured for CG-SDT becomes valid again. In the meantime, the UE may decode PDCCH based on the SSB over the initial BWP in which it completed the RA procedure. In one option, the UE may indicate, during the RA procedure in initial BWP, that the UE switched BWP from dedicated CG-SDT BWP possibly with an indication of a reason of “no valid SSB for CG-SDT”.

In a further embodiment, if the switching to initial BWP for RA was triggered due to lack of UL resource(s), the UE may autonomously switch back to the dedicated BWP configured with CG-SDT when there is valid UL resource(s). In one option, the UE may indicate, during the RA procedure in initial BWP, that the UE switched BWP from dedicated CG-SDT BWP possibly with an indication of a reason of “no valid UL resource(s)”.

According to one example, the UE may indicate, e.g., via MAC/RRC signaling in the initial BWP, that the UE will switch back to dedicated CG-SDT BWP in case CG-SDT condition is valid again. For example, the CG-SDT condition may be considered valid again when there is valid TA if the RA trigger is “no valid TA”, or when there is valid SSB for CG-SDT resource again if the RA trigger is due to no valid SSB, or when there is valid UL resource(s) if the RA trigger is due to lack of UL resource(s).

A further example embodiment may provide method for BWP switching upon command from the network. In one example, DCI format for BWP switching may be configured in RRC release with suspend, together with the CG-SDT resource configuration if it is on a dedicated BWP, which would result in the UE performing more PDCCH decodings in INACTIVE mode to detect the DCI for BWP switching. In an embodiment, the DCI can be decoded in initial BWP. Alternatively, the BWP switching can be done via MAC CE without requiring the UE to monitor the DCI format configured for BWP switching in the initial BWP. The UE may move to dedicated BWP after the processing time or ACK has been sent for the MAC CE plus processing time at the network side.

In one embodiment, when timing advance timer (TAT) for CG-SDT expires while the CG-SDT resources are configured on dedicated BWP, the UE may trigger RA procedure immediately. Alternatively or additionally, the network can send PDCCH order to the UE over the dedicated BWP, which causes the UE to switch to initial BWP for RA procedure. This can account for the case where the UE no longer has UL but the SDT procedure is still ongoing, for example.

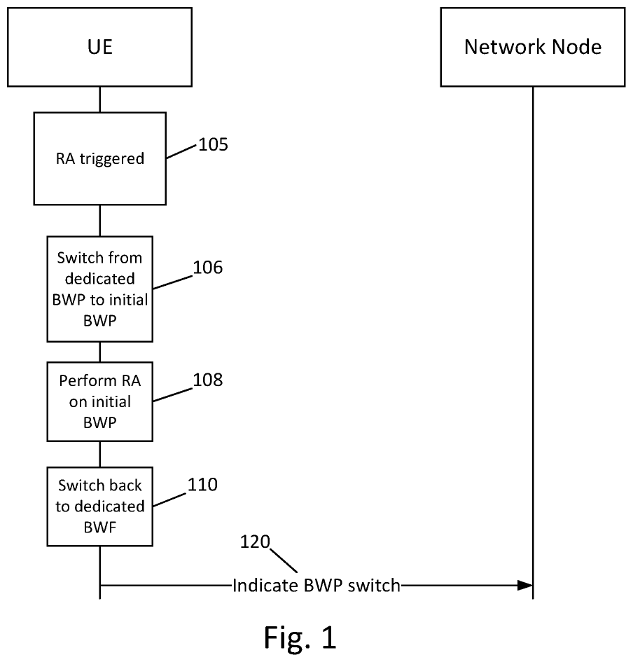

FIG. 1 illustrates an example signaling diagram for a BWP switching operation during SDT procedure, according to certain example embodiments. More specifically, FIG. 1 illustrates an example of UE autonomous switching back to a dedicated BWP configured with CG-SDT, according to an embodiment.

As illustrated in the example of FIG. 1, at 105, RA may be triggered. For instance, the RA procedure may be triggered when there is no valid TA, when there is no valid SSB for CG-SDT, and/or when SR is triggered due to lack of UL resources. As further illustrated in the example of FIG. 1, at 106, the UE may switch from the dedicated BWP to the initial BWP and, at 108, may perform RA on the initial BWP. In one embodiment, when the switching to the initial BWP for RA procedure was triggered due to no valid TA, no valid SSB for CG-SDT and/or lack of UL resources, at 110, the UE may autonomously switch back to the dedicated BWP configured with CG-SDT. For example, the UE may switch back to the dedicated BWP when the UE obtains valid TA again upon the RA completion or when the UE SSB configured for CG-SDT becomes valid again. In one option, the UE may switch to the dedicated BWP upon sending an acknowledgement for the contention resolution message (e.g., Msg4/MsgB).

According to an embodiment, at 120, the UE may optionally indicate, e.g., via MAC or RRC signaling in the initial BWP and/or in the dedicated BWP, that the UE switched back to dedicated CG-SDT BWP in case the CG-SDT condition is valid again. In one embodiment, the UE may indicate during the RA procedure in initial BWP that the UE switched BWP from the dedicated CG-SDT BWP optionally with an indication of a reason for the switch as having “no-valid TA” and/or having “no valid SSB for CG-SDT”. According to an embodiment, when the switching to the initial BWP for RA procedure was triggered due to no valid SSB for CG-SDT, the UE may decode PDCCH based on the SSB over the initial BWP in which it completed the RA procedure.

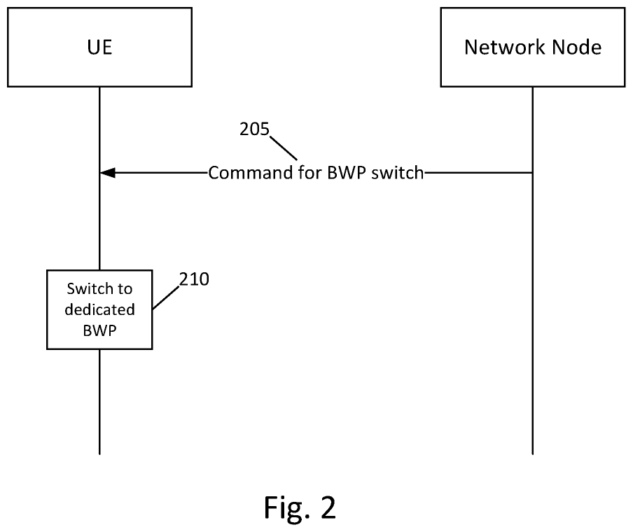

FIG. 2 illustrates an example signaling diagram for a BWP switching operation during SDT procedure, according to certain example embodiments. More specifically, FIG. 2 illustrates an example of BWP switching upon command from a network or network node, according to an embodiment.

As illustrated in the example of FIG. 2, at 205, the network node may transmit a command to a UE to switch to a BWP configured with CG-SDT. In one example embodiment, the command may include a DCI for BWP switching whose format is configured in RRC release together with the CG-SDT resource configuration if it is on a dedicated BWP. This may cause the UE to perform more PDCCH decodings in inactive mode. According to an embodiment, the DCI may be decoded by the UE in the initial BWP. As further illustrated in the example of FIG. 2, at 210, the UE may switch to the dedicated BWP configured with CG-SDT.

In another embodiment, the command for BWP switching may be performed via MAC CE, e.g., without requiring the UE to monitor DCI supporting BWP switching in the initial BWP. According to an embodiment, the UE may then switch to the dedicated BWP after the processing time or ACK has been sent for the MAC CE plus processing time at the network side.

According to some example embodiments, when TAT for CG-SDT expires while the CG-SDT resources are configured on the dedicated BWP, the UE may trigger RA procedure immediately. Alternatively, the network node may send PDCCH order to the UE over the dedicated BWP, which causes the UE to switch to the initial BWP for RA procedure.

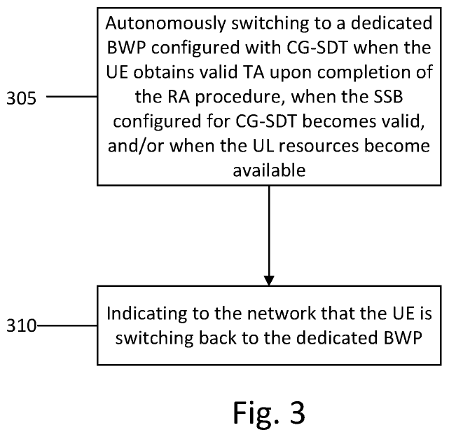

FIG. 3 illustrates an example flow diagram of a method for BWP switching during SDT procedure, according to an example embodiment. For instance, the method of FIG. 3 may depict an example of a UE autonomously switching back to a dedicated BWP configured with CG-SDT. Therefore, in certain example embodiments, the flow diagram of FIG. 3 may be performed by a communication device in a communications system, such as LTE or 5G NR. For instance, in some example embodiments, the communication device performing the method of FIG. 3 may include a UE, sidelink (SL) UE, wireless device, mobile station, IoT device, UE type of roadside unit (RSU), customer premises equipment (CPE), other mobile or stationary device, or the like. For example, in one embodiment, the method of FIG. 3 may be performed by a UE that is at least initially in inactive mode.

As illustrated in the example of FIG. 3, when a switch to an initial BWP for a RA procedure was triggered due to at least one of no valid TA or no valid SSB for configured CG-SDT or lack of UL resources, the method may include, at 305, autonomously switching to a dedicated BWP configured with CG-SDT when the UE obtains valid TA upon completion of the RA procedure or when the SSB configured for CG-SDT becomes valid or the UL resources become available. In one example embodiment, the autonomously switching 305 may include switching to the dedicated BWP upon sending an acknowledgement for a contention resolution message of the RA procedure.

In some example embodiments, the method of FIG. 3 may also include, at 310, indicating to a network, for example via MAC or RRC signaling in the initial BWP, that the UE is switching back to the dedicated BWP in case the CG-SDT condition is valid again. According to an embodiment, the method may include providing an indication to the network, during the RA procedure in the initial BWP, that the UE switched from the dedicated BWP. In one example embodiment, the indication may include an indication of a reason for the switch, such as having no valid TA, having no valid SSB for the CG-SDT, and/or lack of UL resources.

According to certain example embodiments, when the switching to the initial BWP for the RA procedure was triggered due to no valid SSB for the CG-SDT, the method may include decoding physical downlink control channel (PDCCH) based on the SSB over the initial BWP for which the UE completed the RA procedure.

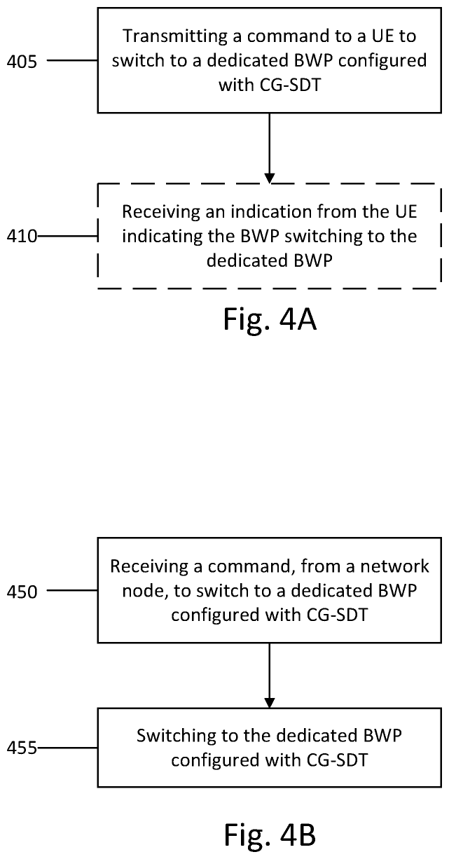

FIG. 4A illustrates an example flow diagram of a method for BWP switching during SDT procedure, according to one embodiment. For example, the method of FIG. 4A may depict an example of BWP switching upon a command from the network. In certain example embodiments, the flow diagram of FIG. 4A may be performed by a network entity or network node in a communications system, such as LTE or 5G NR. In some example embodiments, the network entity performing the method of FIG. 4A may include or be included in a base station, access node, node B, eNB, gNB, gNB-DU, gNB-CU, NG-RAN node, 5G node, transmission-reception points (TRPs), high altitude platform stations (HAPS), relay station, or the like.

As illustrated in the example of FIG. 4A, the method may include, at 405, transmitting a command, to a UE that is in inactive mode, to switch to a dedicated BWP configured with CG-SDT. In an embodiment, the command may include a DCI for BWP switching whose format is configured in RRC release together with the CG-SDT resource configuration if it is on a dedicated BWP. According to one embodiment, the transmitting 405 of the command may include transmitting the command to switch to the BWP via MAC CE. In an example embodiment, the method may include transmitting a PDCCH order to the UE over the dedicated BWP to cause the UE to switch to an initial BWP for RA procedure. According to some embodiments, the method may optionally include, at 410, receiving an indication from the UE indicating the BWP switching to the dedicated BWP.

FIG. 4B illustrates an example flow diagram of a method for BWP switching during SDT procedure, according to an example embodiment. For instance, the method of FIG. 4B may depict an example of BWP switching upon a command from the network. In certain example embodiments, the flow diagram of FIG. 4B may be performed by a communication device in a communications system, such as LTE or 5G NR. For instance, in some example embodiments, the communication device performing the method of FIG. 4B may include a UE, sidelink (SL) UE, wireless device, mobile station, IoT device, UE type of roadside unit (RSU), customer premises equipment (CPE), other mobile or stationary device, or the like. For example, in one embodiment, the method of FIG. 4B may be performed by a UE that is at least initially in inactive mode.

As illustrated in the example of FIG. 4B, the method may include, at 450, receiving a command from a network node to switch to a dedicated BWP configured with CG-SDT. In an embodiment, the command may include a DCI for BWP switching whose format is configured in RRC release together with the CG-SDT resource configuration if it is on the dedicated BWP. In a further embodiment, the receiving 450 may include receiving the command to switch to the bandwidth part (BWP) via medium access control (MAC) control element (CE).

According to certain embodiments, the method may include, at 455, switching to the dedicated BWP configured with CG-SDT. In some embodiments, e.g., when the command is received via MAC CE, the switching 455 may include switching to the dedicated BWP after a processing time or acknowledgement has been sent for the MAC CE plus processing time at the network node. According to some embodiments, the method may optionally include transmitting an indication, to the network node, of the switch to the dedicated BWP configured with CG-SDT.

In certain embodiments, when the command is indicated via DCI, the method may include decoding the DCI in an initial BWP. According to an embodiment, when a timing advance timer (TAT) for the CG-SDT expires while the CG-SDT resources are configured on the dedicated BWP, the method may include triggering the RA procedure. In some embodiments, the method may include receiving a PDCCH order, from the network node, over the dedicated BWP to cause the UE to switch to the initial BWP for the RA procedure.

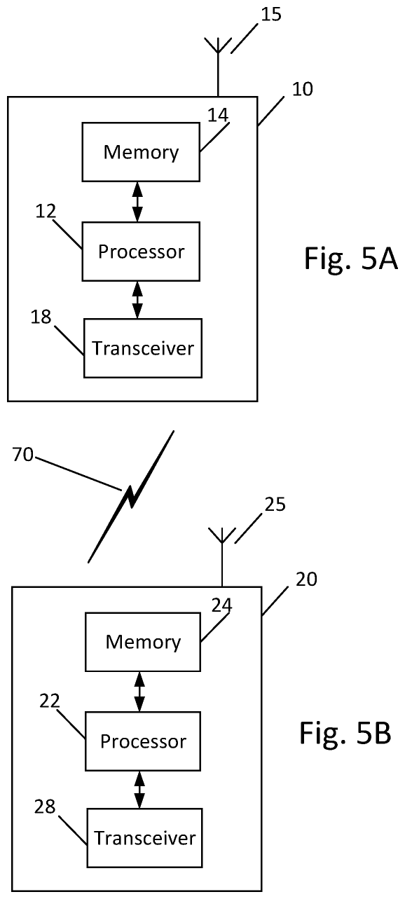

FIG. 5A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, RRH, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be located in a substantially same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 5A.

As illustrated in the example of FIG. 5A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 5A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an example embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some example embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an example embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some example embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain example embodiments, apparatus 10 may be or may be a part of a network element or RAN node, such as a base station, access point, Node B, eNB, gNB, TRP, RRH, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIG. 1, 2, or 4A, or any other method described herein. In some embodiments, as discussed herein, apparatus 10 may be configured to perform a process relating to BWP switching during SDT procedure, for example.

FIG. 5B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, CPE, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 5B.

As illustrated in the example of FIG. 5B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, CPE, or the like, for example. According to certain embodiments, apparatus 20 may be controlled by memory 24 and processor 22 to perform the functions associated with any of the embodiments described herein, such as one or more of the operations illustrated in, or described with respect to, FIG. 1, 2, 3, or 4B, or any other method described herein. For example, in an embodiment, apparatus 20 may be controlled to perform a process relating to BWP switching during SDT procedure, as described in detail elsewhere herein.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments are configured to provide methods, apparatuses and/or systems that enable BWP switching back to CG-SDT BWP during SDT procedure in inactive mode when the UE has valid TA or the SSB(s) become valid again or UL resources become available. As a result, example embodiments can make best use of the configured CG-SDT resources. Accordingly, the use of certain example embodiments results in improved functioning of communications networks and their nodes, such as base stations, eNBs, gNBs, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1-59. (canceled)

60. An apparatus, comprising:
at least one processor; and
at least one memory comprising computer program code,
the at least one memory and computer program code configured, with the at least one processor, to cause the apparatus at least to:
when a switch to an initial bandwidth part for a random access procedure is triggered due to a configured grant-small data transmission condition becoming invalid,
autonomously switching to a dedicated bandwidth part configured with the configured grant-small data transmission when the configured grant-small data transmission condition becomes valid.

61. The apparatus of claim 60, wherein the configured grant-small data transmission condition being invalid comprises at least one of no valid timing advance, no valid synchronization signal block for configured grant-small data transmission, or lack of uplink resources, and
wherein the configured grant-small data transmission condition becoming valid comprises at least one of obtaining valid timing advance upon the random access procedure completion, the synchronization signal block configured for configured grant-small data transmission becoming valid, or uplink resources becoming available.

62. The apparatus of claim 60, wherein, when autonomously switching, the at least one memory and computer program code are configured, with the at least one processor, to cause the apparatus at least to:
switch to the dedicated bandwidth part upon sending an acknowledgement for a contention resolution message of the random access procedure.

63. The apparatus of claim 60, wherein the at least one memory and computer program code are configured, with the at least one processor, to cause the apparatus at least to:
indicate to a network, via medium access control or radio resource control signaling in the initial bandwidth part, that the apparatus is switching back to the dedicated bandwidth part in case the configured grant-small data transmission condition is valid again.

64. The apparatus of claim 60, wherein the at least one memory and computer program code are configured, with the at least one processor, to cause the apparatus at least to:
provide an indication to the network, during the random access procedure in the initial bandwidth part, that the apparatus switched from the dedicated bandwidth part.

65. The apparatus of claim 64, wherein the indication comprises an indication of a reason for the switch as at least one of having no valid timing advance, having no valid synchronization signal block for the configured grant-small data transmission, or a lack of uplink resources.

66. The apparatus of claim 61, wherein, when the switching to the initial bandwidth part for the random access procedure was triggered due to no valid synchronization signal block for the configured grant-small data transmission, the at least one memory and computer program code configured, with the at least one processor, to cause the apparatus at least to:
decode physical downlink control channel based on the synchronization signal block over the initial bandwidth part in which the apparatus completed the random access procedure.

67. The apparatus of claim 60, wherein the apparatus comprises a user equipment.

68. A method, comprising:
when a switch to an initial bandwidth part for a random access procedure is triggered due to a configured grant-small data transmission condition becoming invalid,
autonomously switching, by a user equipment, to a dedicated bandwidth part configured with the configured grant-small data transmission when the configured grant-small data transmission condition becomes valid.

69. The method of claim 68, wherein the configured grant-small data transmission condition being invalid comprises at least one of no valid timing advance, no valid synchronization signal block for configured grant-small data transmission, or lack of uplink resources, and
wherein the configured grant-small data transmission condition becoming valid comprises at least one of obtaining valid timing advance upon the random access procedure completion, the synchronization signal block configured for configured grant-small data transmission becoming valid, or uplink resources becoming available.

70. The method of claim 68, wherein the autonomously switching comprises:
switching to the dedicated bandwidth part upon sending, by the user equipment, an acknowledgement for a contention resolution message of the random access procedure.

71. The method of claim 68, comprising:
indicating to a network, via medium access control or radio resource control signaling in the initial bandwidth part, that the user equipment is switching back to the dedicated bandwidth part in case the configured grant-small data transmission condition is valid again.

72. The method of claim 68, comprising:
providing an indication to the network, during the random access procedure in the initial bandwidth part, that the user equipment switched from the dedicated bandwidth part.

73. The method of claim 72, wherein the indication comprises an indication of a reason for the switch as at least one of having no valid timing advance, having no valid synchronization signal block for the configured grant-small data transmission, or a lack of uplink resources.

74. The method of claim 69, wherein, when the switching to the initial bandwidth part for the random access procedure was triggered due to no valid synchronization signal block for the configured grant-small data transmission, the method comprises:
decoding physical downlink control channel based on the synchronization signal block over the initial bandwidth part in which the apparatus completed the random access procedure.

75. An apparatus, comprising:
at least one processor; and
at least one memory comprising computer program code,
the at least one memory and computer program code configured, with the at least one processor, to cause the apparatus at least to:
receive a first indication, from a user equipment, during a random access procedure in an initial bandwidth part of the user equipment, that the user equipment switched from a dedicated bandwidth part;
receive, from the user equipment, an acknowledge for a contention resolution message of the random access procedure; and
receive a second indication via medium access control or radio resource control signaling in the initial bandwidth part, that the user equipment is switching back to the dedicated bandwidth part in case a configured grant-small data transmission condition of the dedicated bandwidth part is valid again.

76. The apparatus of claim 75, wherein the first indication comprises an indication of a reason for the switch as at least one of having no valid timing advance, having no valid synchronization signal block for the configured grant-small data transmission, or a lack of uplink resources.

77. The apparatus of claim 75, wherein the configured grant-small data transmission condition being valid comprises at least one of obtaining valid timing advance upon the random access procedure completion, the synchronization signal block configured for configured grant-small data transmission becoming valid, or uplink resources becoming available.
